(19) United States
(12) Patent Application Publication
(10) Pub. No.: US 2024/0176853 A1
(43) Pub. Date: May 30, 2024

(54) DYNAMIC DATA BROKER SERVICES

(71) Applicant: GM Global Technology Operations LLC, Detroit, MI (US)

(72) Inventors: Donald K. Grimm, Utica, MI (US); Amin Abdossalami, Markham (CA); Fan Bai, Ann Arbor, MI (US); Derek Beaulieu Ancrum, Pickering (CA)

(21) Appl. No.: 18/060,022

(22) Filed: Nov. 30, 2022

(51) Int. Cl. H04W 12/02; G06F 16/9537; G06F 21/62

(52) U.S. Cl. CPC H04W 12/02; G06F 16/9537; G06F 21/6245

(57) ABSTRACT

A system for providing dynamic data broker services includes a plurality of participant vehicle having onboard sensors adapted to collect data and send such data to the system via a wireless communication network, a database adapted to store the data received from the plurality of participant vehicles, an application program interface adapted to receive at least one request for data from at least one user, a supervisory engine adapted to consolidate and prioritize the at least one request for data, the system further adapted to identify data that is relevant to the at least one request within the data stored within the database, tailor a response to the at least one request for data based on privacy considerations, spatial considerations and temporal considerations, and send the response to the at least one user.

### INTRODUCTION

The present disclosure relates to a dynamic data broker that is adapted to collect data from participating vehicles (crowd-sourcing) and using such data to fulfill requests for data from users. Current systems collect and share data, however, current systems do not modify and filter collected data based on privacy, spatial and temporal considerations to make sure such data is relevant and useful to the requestor and that providing such data to a requestor does not violate applicable privacy laws and policies.

Thus, while current systems and methods achieve their intended purpose, there is a need for a new and improved system and method for crowd sourcing data from a plurality of participant vehicles and modifying and filtering the collected data based on privacy, spatial and temporal considerations prior to sharing the collected data with a requestor.

### SUMMARY

According to several aspects of the present disclosure, a system for providing dynamic data broker services includes a plurality of participant vehicles having onboard sensors adapted to collect data and send such data to the system via a wireless communication network, a database adapted to store the data received from the plurality of participant vehicles, an application program interface adapted to receive at least one request for data from at least one user, a supervisory engine adapted to consolidate and prioritize the at least one request for data, the system further adapted to identify data that is relevant to the at least one request within the data stored within the database, tailor a response to the at least one request for data based on privacy considerations, spatial considerations and temporal considerations, and send the response to the at least one user.

According to another aspect, the system further includes a data engine, the data engine adapted to receive data from a plurality of external sources via the wireless communication network, and to combine, the data received from the plurality of external sources with the data received from the plurality of participant vehicles.

According to another aspect, the system further includes a policy database adapted to store privacy laws and policies therein, and a privacy engine, the privacy engine adapted to process the at least one request to identify limitations on data that may be provided to the at least one user based on the privacy laws and policies stored within the policy database that are applicable to the at least one request, wherein, when the system tailors a response to the at least one request for data based on privacy considerations, the privacy engine is adapted to modify and filter the identified data that is relevant to the at least one request based on the identified limitations.

According to another aspect, the privacy engine is adapted to modify and filter the identified data that is relevant to the at least one request based on the identified limitations and an identity of the at least one user.

According to another aspect, the privacy engine is adapted to modify and filter the identified data that is relevant to the at least one request by at least one of, redacting image data, re-encoding periodic data as event data, and converting image data to semantic data.

According to another aspect, the system further includes a spatial engine adapted to identify distance and location-based aspects of the at least one request, wherein, when the system tailors a response to the at least one request for data based on spatial considerations, the spatial engine is adapted to modify and filter the identified data that is relevant to the at least one request based on the identified distance and location-based aspects of the at least one request.

According to another aspect, the system further includes a temporal engine adapted to identify time and frequency-based aspects of the at least one request, wherein, when the system tailors a response to the at least one request for data based on temporal considerations, the temporal engine is adapted to modify and filter the identified data that is relevant to the at least one request based on the identified time and frequency-based aspects of the at least one request.

According to another aspect, the system further includes a compute engine that is adapted to apply functions that can be applied to the at least one request, wherein such functions may be pulled from a library stored within the system and may be identified within the at least one request, wherein, when consolidating and prioritizing the at least one request for data with the supervisory engine, the system is further adapted to process the at least one request with the compute engine and to apply applicable functions.

According to another aspect, the supervisory engine is further adapted to identify a need for more data of a certain type, and send, via the wireless communication network, feedback to the plurality of participant vehicles, and prompt the plurality of participant vehicles to collect more data of the certain type.

According to another aspect, the privacy engine is further adapted to identify limitations on data that may be collected based on privacy laws and policies stored within the policy database, and to send, via the wireless communication network, feedback to the plurality of participant vehicles, and prompt the plurality of participant vehicles to collect and send data in compliance with identified limitations.

According to several aspects of the present disclosure, a method of providing dynamic data broker services includes collecting data with onboard sensors within a plurality of participant vehicles, receiving, from the plurality of participant vehicles, via a wireless communication network, the data collected by the plurality of participant vehicles and storing the data received from the plurality of participant vehicles within a database of a dynamic data broker system, receiving, from at least one user, via an application program interface, at least one request for data, consolidating and prioritizing the at least one request for data with a supervisory engine, receiving data, from a plurality of external sources, via the wireless communication network, combining, with a data engine, the data received from the plurality of external sources with the data received from the plurality of participant vehicles, identifying data that is relevant to the at least one request within the data stored within the database of the dynamic data broker system, tailoring a response to the at least one request for data based on privacy considerations, spatial considerations and temporal considerations, and sending the response to the at least one user.

According to another aspect, the tailoring a response to the at least one request for data based on privacy considerations includes processing the at least one request with a privacy engine adapted to identify limitations on data that may be provided to the at least one user based on privacy laws and policies, stored within a policy database, and applicable to the at least one request, and modifying and filtering, with the privacy engine, the identified data that is relevant to the at least one request based on the identified limitations.

According to another aspect, the modifying and filtering, with the privacy engine, the identified data that is relevant to the at least one request based on the identified limitations, further includes modifying and filtering, with the privacy engine, the identified data that is relevant to the at least one request based on an identity of the at least one user.

According to another aspect, the modifying and filtering, with the privacy engine, the identified data that is relevant to the at least one request based on the identified limitations includes at least one of redacting image data, re-encoding periodic data as event data, and converting image data to semantic data.

According to another aspect, the tailoring a response to the at least one request for data based on spatial considerations includes, processing the at least one request with a spatial engine adapted to identify distance and location-based aspects of the at least one request, and modifying and filtering, with the spatial engine, the identified data that is relevant to the at least one request based on the identified distance and location-based aspects of the at least one request.

According to another aspect, the tailoring a response to the at least one request for data based on temporal considerations includes processing the at least one request with a temporal engine adapted to identify time and frequency-based aspects of the at least one request, and modifying and filtering, with the temporal engine, the identified data that is relevant to the at least one request based on the identified time and frequency-based aspects of the at least one request.

According to another aspect, the consolidating and prioritizing the at least one request for data with the supervisory engine further includes processing the at least one request with a compute engine adapted to apply functions that can be applied to the at least one request, wherein such functions may be pulled from a library stored within the system and may be identified within the at least one request.

According to another aspect, the consolidating and prioritizing the at least one request for data with the supervisory engine further includes identifying, with the supervisory engine, a need for more data of a certain type, and sending, via the wireless communication network, feedback to the plurality of participant vehicles, and prompting the plurality of participant vehicles to collect more data of the certain type.

According to another aspect, the collecting data with onboard sensors within a plurality of participant vehicles, further includes identifying, with the privacy engine, limitations on data that may be collected based on privacy laws and policies stored within the policy database, and sending, via the wireless communication network, feedback to the plurality of participant vehicles, and prompting the plurality of participant vehicles to collect and send data in compliance with identified limitations.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a dynamic data broker system according to an exemplary embodiment; and

FIG. 2 is a flow chart illustrating a method according to an exemplary embodiment.

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

### DETAILED DESCRIPTION

The following description is merely exemplary in nature and is not intended to limit the present disclosure, application, or uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. Although the figures shown herein depict an example with certain arrangements of elements, additional intervening elements, devices, features, or components may be present in actual embodiments. It should also be understood that the figures are merely illustrative and may not be drawn to scale.

As used herein, the term “vehicle” is not limited to automobiles. While the present technology is described primarily herein in connection with automobiles, the technology is not limited to automobiles. The concepts can be used in a wide variety of applications, such as in connection with aircraft, marine craft, other vehicles, and consumer electronic components.

The term data processor refers to a non-generalized, electronic control device having a preprogrammed digital computer or processor, memory or non-transitory computer readable medium used to store data such as control logic, software applications, instructions, computer code, data, lookup tables, etc., and a transceiver [or input/output ports]. computer readable medium includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code.

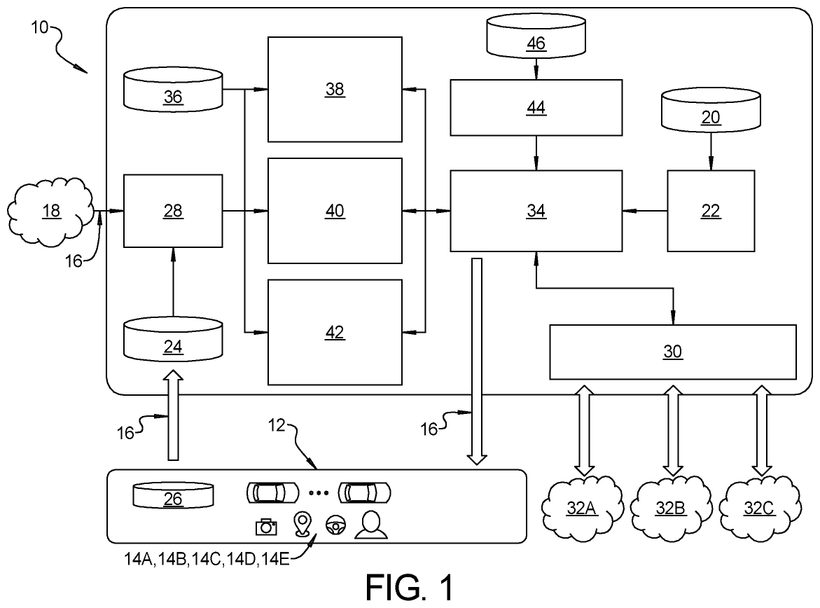

Referring to FIG. 1, a system 10 for providing dynamic data broker services includes a plurality of participant vehicles 12 having onboard sensors 14A, 14B, 14C, 14D adapted to collect data and send such data to the system 10 via a wireless communication network 16. The system 10 includes a wireless communication module that is adapted to allow wireless communication between the system 10 and each of the plurality of participant vehicles 12 and other external sources 18 over wireless communication channels such as a WLAN, 4G/LTE or 5G network, or the like.

Each one of the plurality of participant vehicles 12 is a vehicle for which an owner has agreed to allow collection of data by the existing onboard sensor systems within the vehicle 12, and uploading of such data to the dynamic data broker service system 10. Each such owner of one of the plurality of participant vehicles 12 agrees to terms and conditions which dictate the terms under which data will be collected from their vehicle and uploaded to the dynamic data broker system 10. Additionally, customers who want to access the data broker system 10 execute service level agreements with the owner of the system 10. Service level agreements are stored within a database 20 within the dynamic data broker system 10, and when requests are received by the dynamic data broker system 10, a service level agreement engine 22 assesses the request and reply in light of the terms of the applicable service level agreement. The service level agreements cover aspects such as performance of the system (e.g. guarantees that data is updated within one minute) and provides for customer specific access privileges (e.g. one service level agreement will provide access for the customer to external imagery, while another service level agreement for a different customer may not).

The data collected by the plurality of participant vehicles 12 includes data related to all aspects of the vehicles 12. Visual sensors 14A, such as cameras, capture images from within and around the vehicle 12 which can be interpreted by data processors to identify people and items within the vehicle 12 as well as objects, such as signs, traffic/construction markers, lane markings, etc. near and around the vehicle. A participant vehicle 12 may also include non-visual sensors 14B that are adapted to detect a position, velocity, and direction of travel of objects in the environment surrounding the vehicle 12. By way of non-limiting examples, non-visual sensors 14B may include one or more sensors such as radar, LiDAR, and infrared sensors, however, it is to be appreciated that other sensors that employ non-visual techniques to detect the presence of objects may be used as well.

Global positioning systems (GPS) 14C track movement and speed of the vehicle. Other sensors 14D monitor steering wheel angle, accelerator and brake pedal application. Such sensors 14D may also monitor when windshield wipers are on or when headlights are active to deduce weather conditions. Passive sensors 14E within the vehicle 12, such as pressure sensors within the seats can provide insight on the number of passengers within the vehicle 12 and the respective locations of the passengers within the vehicle 12. Driver monitoring systems and their various sensors can monitor and track the attentiveness of a driver within a vehicle 12. The above examples are merely illustrative in nature, and not meant to be limiting. It should be understood by those skilled in the art, that a dynamic data broker system 10 in accordance with the novel features of the present disclosure may collect any type of data collected by any type of sensor used within a participant vehicle 12.

Once data has been collected and sent to the system 10, the data is stored within a database 24 for future access by the system 10. In one exemplary embodiment, data is collected from the plurality of participant vehicles 12 and stored in a remote database 26 which periodically uploads, via the wireless communication network 16, the data collected from the plurality of participant vehicles 12. In another exemplary embodiment, data is collected directly from each of the plurality of participant vehicles 12 via the wireless communication network 16.

In an exemplary embodiment, the system 10 further includes a data engine 28 adapted to receive data from a plurality of external sources 18 via the wireless communication network 16. The data engine 28 is a data processor within the system 10 that identifies situations where the data collected from the plurality of participant vehicles 12 is insufficient. In such a scenario, the data engine 28 reaches out to external sources 18, such as weather databases, DOT databases, or other dynamic data broker systems, for example, to obtain additional data necessary to fulfill a request. Data collected from the plurality of external sources 18 is combined with the data received from the plurality of participant vehicles 12. By way of non-limiting example, a request is asking for current data related to weather conditions on a particular stretch of a specified highway. There are very few participant vehicles 12 travelling on that stretch of highway, thus, the data engine 28 reaches out to a weather database to get additional information on the current weather conditions for that area and combines such information with whatever data is available from participant vehicles 12 travelling on that stretch of highway.

An application program interface 30 is adapted to receive at least one request from at least one user 32. As shown, the application program interface (API) 30 is receiving a request from three different users 32A, 32B, 32C. Users 32 are individuals, companies or organizations that may have a need for the type of data that is collected from the plurality of participant vehicles 12 by the system 10. For example, a first user 32A may be a company specializes in providing mobility related services, and a request from such a user 32A may be related to data that will help that user 32A identify high traffic areas and/or in providing mobility services to their customers. In another example, a second user 32B may be a police officer or emergency services provider such as an ambulance, and a request from such a user 32B may be related to identifying a specific location of an individual (one of the participant vehicles 12), or to identify a quickest route to arrive at an accident scene. In still another example, a third user 32C may be the department of transportation, and a request from the department of transportation (DOT) may be related to data which will help the DOT identify sections of roadway that need immediate repair, or an intersection that needs augmented traffic controls, such as a traffic light rather than a stop sign.

The system 10 includes a supervisory engine 34 that is adapted to consolidate and prioritize the at least one request for data. The supervisory engine 34 is a data processor within the system 10 that consolidates multiple requests for efficiency. For example, if multiple users 32 are requesting the same data, the multiple requests may be consolidated into a single request for which a common reply will be sent. The supervisory engine 34 further prioritizes the at least one request for data. For example, if multiple users 32 are requesting multiple different types of data, the supervisory engine 34 is adapted to identify users 32 who are police or emergency service providers and give priority to their requests.

In an exemplary embodiment, the supervisory engine 34 is further adapted to identify when more data of a certain type is needed. The supervisory engine 34 may identify a trend of requests asking for a particular type of data, or data for a specific time frame or related to a specific area or roadway, or that there is routinely insufficient data to satisfy certain requests. In such a scenario, the supervisory engine 34 is adapted to send, via the wireless communication network 16, feedback to the plurality of participant vehicles 12, and instruct the plurality of participant vehicles 12 to collect more data of the certain type. Thus, the system 10 is constantly adapting to trends in data requests and updating feedback to the plurality of participant vehicles 12 to ensure that relevant and useful data is being collected by the plurality of participant vehicles 12 and that the system 10 will be equipped to provide useful responses to requests received by the system 10.

In response to the at least one request, the system 10 is adapted to identify data that is relevant to the at least one request. The system 10 looks at the data stored within the database 24, as well as the data collected by the data engine 28 from external sources 18. The system 10 uses the data that is identified as relevant to tailor a response to the at least one request for data based on privacy considerations, spatial considerations and temporal considerations, and sends a response to the at least one user 32.

In an exemplary embodiment, the system 10 further includes a policy database 36 adapted to store privacy laws and policies therein, and a privacy engine 38. The privacy engine 38 is a data processor adapted to process the at least one request and identify limitations on data that may be provided to the at least one user 32 based on the privacy laws and policies stored within the policy database 36 that are applicable to the at least one request. When the system 10 tailors a response to the at least one request for data based on privacy considerations, the privacy engine 38 is adapted to modify and filter the identified data that is relevant to the at least one request based on the identified limitations.

For example, many privacy laws have strict limitations on collecting and sharing data that would or could be used to identify an individual's home address or locations to which an individual travels. Thus, privacy laws or policies may not allow the system 10 to collect data related to a participant vehicle 12 when the participant vehicle 12 is within a pre-determined range of the home address for that participant vehicle 12 or any final destination for that participant vehicle 12. Thus, if the system 10 is collecting data related to the routes and roadways that a participant vehicle travels, the privacy engine 38 would remove the data collected when the participant vehicle 12 is within the pre-determined range of the home address or any final destination. Such information may not be collected by the system 10 at all, and if such information is collected by the system 10, such information would be removed from any response provided to a request.

In another exemplary embodiment, the privacy engine 38 is adapted to modify and filter the identified data that is relevant to the at least one request based on the identified limitations and an identity of the at least one user 32. For example, using the facts given above, privacy laws and policies prohibit collecting/sharing data that would or could be used to identify an individuals home address or final destination. Such privacy laws and policies may not apply, however, to police agencies and/or emergency service providers. Thus, if the requestor is a police agency or an emergency service provider, the privacy engine 38 is adapted to provide, for example, route data for a participant vehicle 12 extending from the home address all the way to the final destination.

In other exemplary embodiments, the privacy engine 38 is adapted to modify and filter the identified data that is relevant to the at least one request by at least one of redacting image data, re-encoding periodic data as event data, and converting image data to semantic data.

By way of a non-limiting example, image data that is collected by cameras within the plurality of participant vehicles 12 may show identifying features such as license plate numbers, vehicle identification numbers or faces of passengers within a participant vehicle 12. The privacy engine 38 can obscure or redact such features from such images before providing such images within a response to a request.

In another example, information included within image data can be converted to semantic data. Thus, an image may include a stop sign as well as other information (VIN number, license plate numbers, etc.) that cannot be shared. The privacy engine 38 can analyze the image and provide a response that includes semantic data describing that there is a stop sign and the location of the stop sign, without sharing the original image.

In some instances, privacy laws and policies restrict how data may be collected. By way of a non-limiting example, an area (territory, state, country) may have privacy laws that prohibit sharing data that is collected periodically. If the system 10 has collected speed and GPS location information for a participant vehicle every 5 seconds, the system 10 would be prohibited from sharing such information in that area. Thus, the privacy engine 38 is adapted to modify the identified data that is relevant to the at least one request to avoid violating the privacy policies in that area. The privacy engine 38 may, for example, re-encode the data collected by the system 10 and provide data related to the speed and GPS location for the participant vehicle 12 collected upon each application of the brakes. Thus, the data has been re-encoded from periodic data to event based data, and sharing it would not violate the privacy laws and policies for that area.

In another exemplary embodiment, in addition to identifying limitation on data that may be shared, the privacy engine 38 is further adapted to identify limitations on data that may be collected based on privacy laws and policies stored within the policy database. When the privacy engine 38 identifies such limitations, feedback is sent, via the wireless communication network 16, to the plurality of participant vehicles 12 to prompt the plurality of participant vehicles 12 to collect and send data in compliance with identified limitations.

In another exemplary embodiment, the system 10 further includes a spatial engine 40. The spatial engine 40 is a data processor that is adapted to identify distance and location-based aspects of the at least one request. When the system 10 tailors a response to the at least one request for data based on spatial considerations, the spatial engine 40 is adapted to modify and filter the identified data that is relevant to the at least one request based on the identified distance and location-based aspects of the at least one request.

By way of non-limiting example, the system 10 may have data collected by the plurality of participant vehicles 12 wherein data related to speed and GPS location of each participant vehicle 12 is collected every tenth of a mile. Based on the at least one request, data may be required for speed and location collected with more or less resolution (ie. the requestor wants speed and location data collected every 100 meters). The spatial engine 40 may filter the data to provide data with less resolution, or may interpolate the data to fill in the gaps and provide data with higher resolution. In another example, the request may want data collected only when the participant vehicle 12 is traveling upon highways, thus, the spatial engine 40 will filter out data that was collected while participant vehicles 12 traveled on secondary and residential roads.

In another exemplary embodiment, the system 10 further includes a temporal engine 42. The temporal engine 42 is a data processor that is adapted to identify time and frequency-based aspects of the at least one request. When the system 10 tailors a response to the at least one request for data based on temporal considerations, the temporal engine 42 is adapted to modify and filter the identified data that is relevant to the at least one request based on the identified time and frequency-based aspects of the at least one request.

By way of non-limiting example, a request may require data taken on a periodic bases every 15 minutes. The system 10 may have data collected by the plurality of participant vehicles 12 wherein the data was collected periodically every 5 minutes. The temporal engine 42 will filter the data to provide data at 15 minute intervals, per the request. In another example, the system 10 may have data collected by the plurality of participant vehicles 12 taken at all times, 24 hours per day. The at least one request may require data taken only during specific time periods, such as “during rush hour”, “at night” or “on week-days”. The temporal engine 42 will filter out data collected during times not relevant to the request. (i.e., if the request is for data on week-days, the temporal engine will filter out data that was collected on weekends.).

In an exemplary embodiment, the system 10 further includes a compute engine 44. The compute engine 44 is a data processor that is adapted to apply functions that can be applied to the at least one request. Such functions may be pulled from a library 46 stored within the system 10 or, such limitations may be identified within the at least one request. When consolidating and prioritizing the at least one request for data with the supervisory engine 34, the system 10 is further adapted to process the at least one request with the compute engine 44 and to apply applicable functions.

By way of non-limiting example, the system 10 may include capability to perform calculations, to provide a response to the at least one request. Such capability allows the system 10 to provide data that is calculated using input found in the data collected from the plurality of participant vehicles 12 by performing calculations, algorithms, averaging or taking measurements over a moving window. The compute engine 44 can apply calculations techniques or formula to obtain requested data. In response for a request for data related to road roughness, the compute engine 44 may use formula stored therein to calculate road roughness based on the international roughness index.

The international roughness index (IRI) is the roughness index most commonly obtained from measured longitudinal road profiles. It is calculated using a quarter-car vehicle math model, whose response is accumulated to yield a roughness index with units of slope (in/mi, m/km, etc.). Although a universal term, IRI is calculated per wheelpath, but can be expanded to a Mean Roughness Index (MRI) when both wheelpath profiles are collected. However, a user 32 may request road roughness data based on a different index, such as the pavement condition index (PCI). PCI is a numerical index between 0 and 100, which is used to indicate the general condition of a pavement section. The PCI is widely used in transportation civil engineering and asset management, and many municipalities use it to measure the performance of their road infrastructure and their levels of service. Thus, the compute engine 44 will use the appropriate method of calculating road roughness (PCI) based on the at least one request using formulae and methodology found either within the library 46 within the compute engine 44 or as provided within the at least one request.

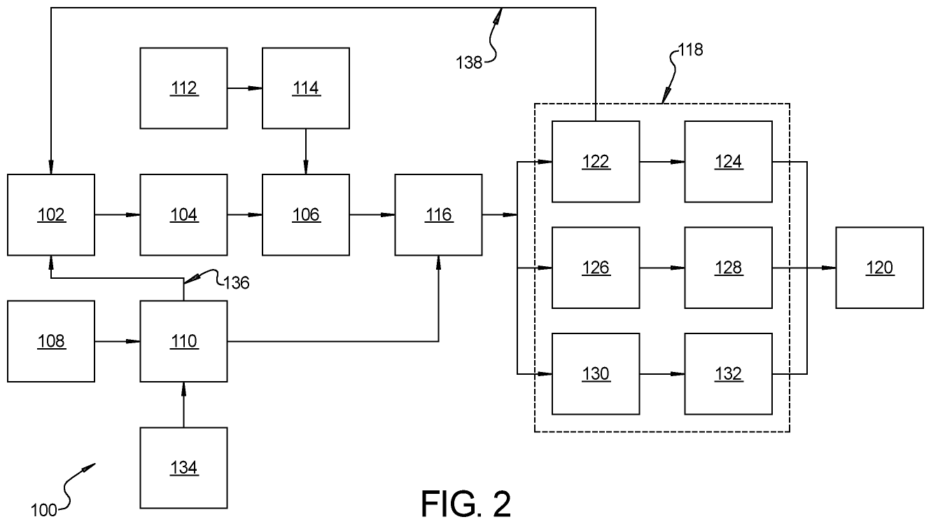

Referring to FIG. 2, a method 100 of providing dynamic data broker services includes, starting at block 102, collecting data with onboard sensors 14A, 14B, 14C, 14D, 14E within a plurality of participant vehicles 12. Moving from block 102 to block 104, the method 100 further includes receiving, from the plurality of participant vehicles 12, via a wireless communication network 16, the data collected by the plurality of participant vehicles 12 and, moving to block 106, storing the data received from the plurality of participant vehicles 12 within a database 24 of a dynamic data broker system 10.

At block 108, the method 100 further includes receiving, from at least one user, via an application program interface 30, at least one request for data, and moving to block 110, consolidating and prioritizing the at least one request for data with a supervisory engine 34. In an exemplary embodiment, at block 112, the method 100 includes receiving data, from a plurality of external sources 18, via the wireless communication network 16, and, moving to block 114, combining, with a data engine 28, the data received from the plurality of external sources 18 with the data received from the plurality of participant vehicles 12.

Moving from block 106 to block 116, the method 100 further includes identifying data that is relevant to the at least one request within the data stored within the database 24 of the dynamic data broker system 10, moving to block 118, tailoring a response to the at least one request for data based on privacy considerations, spatial considerations and temporal considerations, and moving to block 120, sending the response to the at least one user 32.

In an exemplary embodiment, the tailoring a response to the at least one request for data based on privacy considerations at block 118 further includes, moving to block 122, processing the at least one request with a privacy engine 38 adapted to identify limitations on data that may be provided to the at least one user 32 based on privacy laws and policies, stored within a policy database 36, and applicable to the at least one request, and moving to block 124, modifying and filtering, with the privacy engine 38, the identified data that is relevant to the at least one request based on the identified limitations. In another exemplary embodiment, the modifying and filtering, with the privacy engine 38, the identified data that is relevant to the at least one request based on the identified limitations at block 124, further includes modifying and filtering, with the privacy engine 38, the identified data that is relevant to the at least one request based on an identity of the at least one user 32. In another exemplary embodiment, the modifying and filtering, with the privacy engine 38, the identified data that is relevant to the at least one request based on the identified limitations at block 124 includes at least one of redacting image data, re-encoding periodic data as event data, and converting image data to semantic data.

In an exemplary embodiment, the tailoring a response to the at least one request for data based on spatial considerations at block 118 includes, moving to block 126, processing the at least one request with a spatial engine 40 adapted to identify distance and location-based aspects of the at least one request, and, moving to block 128, modifying and filtering, with the spatial engine 40, the identified data that is relevant to the at least one request based on the identified distance and location-based aspects of the at least one request.

In an exemplary embodiment, the tailoring a response to the at least one request for data based on temporal considerations at block 118 includes, moving to block 130, processing the at least one request with a temporal engine 42 adapted to identify time and frequency-based aspects of the at least one request, and, moving to block 132, modifying and filtering, with the temporal engine 42, the identified data that is relevant to the at least one request based on the identified time and frequency-based aspects of the at least one request.

In still another exemplary embodiment the consolidating and prioritizing the at least one request for data with the supervisory engine 34 at block 110 further includes, moving to block 134, processing the at least one request with a compute engine 44 adapted to apply functions that can be applied to the at least one request, wherein such functions may be pulled from a library 46 stored within the system 10 and may be identified within the at least one request.

In still another exemplary embodiment, the consolidating and prioritizing the at least one request for data with the supervisory engine 34 at block 110 further includes identifying, with the supervisory engine 34, a need for more data of a certain type, and sending, via the wireless communication network 16, as indicated by line 136, feedback to the plurality of participant vehicles 12, and prompting the plurality of participant vehicles 12 to collect more data of the certain type at block 102.

In still another exemplary embodiment, the collecting data with onboard sensors 14A, 14B, 14C, 14D, 14E within a plurality of participant vehicles 12 at block 102, further includes identifying, with the privacy engine 38, limitations on data that may be collected based on privacy laws and policies stored within the policy database 36 at block 122, and sending, via the wireless communication network 16, as indicated by line 138, feedback to the plurality of participant vehicles 12, and prompting the plurality of participant vehicles 12 to collect and send data in compliance with identified limitations at block 102.

A system and method of the present disclosure offers the advantage of crowd sourcing data from a plurality of participant vehicles and modifying and filtering the collected data based on privacy, spatial and temporal considerations prior to sharing the collected data with a requestor. This ensures that data can be collected and shared without violating applicable privacy laws and policies.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for providing dynamic data broker services, comprising:
a plurality of participant vehicles having onboard sensors adapted to collect data and send such data to the system via a wireless communication network;
a database adapted to store the data received from the plurality of participant vehicles;
an application program interface adapted to receive at least one request for data from at least one user;
a supervisory engine adapted to consolidate and prioritize the at least one request for data;
the system further adapted to:
identify data that is relevant to the at least one request within the data stored within the database;
tailor a response to the at least one request for data based on privacy considerations, spatial considerations and temporal considerations; and
send the response to the at least one user.

2. The system of claim 1, wherein the system further includes a data engine, the data engine adapted to receive data from a plurality of external sources via the wireless communication network, and to combine, the data received from the plurality of external sources with the data received from the plurality of participant vehicles.

3. The system of claim 1, wherein the system further includes a policy database adapted to store privacy laws and policies therein, and a privacy engine, the privacy engine adapted to process the at least one request to identify limitations on data that may be provided to the at least one user based on the privacy laws and policies stored within the policy database that are applicable to the at least one request, wherein, when the system tailors a response to the at least one request for data based on privacy considerations, the privacy engine is adapted to modify and filter the identified data that is relevant to the at least one request based on the identified limitations.

4. The system of claim 3, wherein the privacy engine is adapted to modify and filter the identified data that is relevant to the at least one request based on the identified limitations and an identity of the at least one user.

5. The system of claim 3, wherein the privacy engine is adapted to modify and filter the identified data that is relevant to the at least one request by at least one of:
redacting image data;
re-encoding periodic data as event data; and
converting image data to semantic data.

6. The system of claim 1, wherein the system further includes a spatial engine adapted to identify distance and location-based aspects of the at least one request, wherein, when the system tailors a response to the at least one request for data based on spatial considerations, the spatial engine is adapted to modify and filter the identified data that is relevant to the at least one request based on the identified distance and location-based aspects of the at least one request.

7. The system of claim 1, wherein the system further includes a temporal engine adapted to identify time and frequency-based aspects of the at least one request, wherein, when the system tailors a response to the at least one request for data based on temporal considerations, the temporal engine is adapted to modify and filter the identified data that is relevant to the at least one request based on the identified time and frequency-based aspects of the at least one request.

8. The system of claim 1, wherein the system further includes a compute engine that is adapted to apply functions that can be applied to the at least one request, wherein such functions may be pulled from a library stored within the system and may be identified within the at least one request, wherein, when consolidating and prioritizing the at least one request for data with the supervisory engine, the system is further adapted to process the at least one request with the compute engine and to apply applicable functions.

9. The system of claim 1, wherein the supervisory engine is further adapted to identify a need for more data of a certain type, and send, via the wireless communication network, feedback to the plurality of participant vehicles, and prompt the plurality of participant vehicles to collect more data of the certain type.

10. The system of claim 1, wherein the privacy engine is further adapted to identify limitations on data that may be collected based on privacy laws and policies stored within the policy database, and to send, via the wireless communication network, feedback to the plurality of participant vehicles, and prompt the plurality of participant vehicles to collect and send data in compliance with identified limitations.

11. A method of providing dynamic data broker services, comprising:
collecting data with onboard sensors within a plurality of participant vehicles;
receiving, from the plurality of participant vehicles, via a wireless communication network, the data collected by the plurality of participant vehicles and storing the data received from the plurality of participant vehicles within a database of a dynamic data broker system;
receiving, from at least one user, via an application program interface, at least one request for data;
consolidating and prioritizing the at least one request for data with a supervisory engine;
receiving data, from a plurality of external sources, via the wireless communication network;
combining, with a data engine, the data received from the plurality of external sources with the data received from the plurality of participant vehicles;
identifying data that is relevant to the at least one request within the data stored within the database of the dynamic data broker system;
tailoring a response to the at least one request for data based on privacy considerations, spatial considerations and temporal considerations; and
sending the response to the at least one user.

12. The method of claim 11, wherein the tailoring a response to the at least one request for data based on privacy considerations includes:
processing the at least one request with a privacy engine adapted to identify limitations on data that may be provided to the at least one user based on privacy laws and policies, stored within a policy database, and applicable to the at least one request; and
modifying and filtering, with the privacy engine, the identified data that is relevant to the at least one request based on the identified limitations.

13. The method of claim 12, wherein the modifying and filtering, with the privacy engine, the identified data that is relevant to the at least one request based on the identified limitations, further includes modifying and filtering, with the privacy engine, the identified data that is relevant to the at least one request based on an identity of the at least one user.

14. The method of claim 12, wherein the modifying and filtering, with the privacy engine, the identified data that is relevant to the at least one request based on the identified limitations includes at least one of:
redacting image data;
re-encoding periodic data as event data; and
converting image data to semantic data.

15. The method of claim 11, wherein the tailoring a response to the at least one request for data based on spatial considerations includes:
processing the at least one request with a spatial engine adapted to identify distance and location-based aspects of the at least one request; and
modifying and filtering, with the spatial engine, the identified data that is relevant to the at least one request based on the identified distance and location-based aspects of the at least one request.

16. The method of claim 11, wherein the tailoring a response to the at least one request for data based on temporal considerations includes:
processing the at least one request with a temporal engine adapted to identify time and frequency-based aspects of the at least one request; and
modifying and filtering, with the temporal engine, the identified data that is relevant to the at least one request based on the identified time and frequency-based aspects of the at least one request.

17. The method of claim 11, wherein the consolidating and prioritizing the at least one request for data with the supervisory engine further includes processing the at least one request with a compute engine adapted to apply functions that can be applied to the at least one request, wherein such functions may be pulled from a library stored within the system and may be identified within the at least one request.

18. The method of claim 11, wherein the consolidating and prioritizing the at least one request for data with the supervisory engine further includes:
identifying, with the supervisory engine, a need for more data of a certain type; and
sending, via the wireless communication network, feedback to the plurality of participant vehicles, and prompting the plurality of participant vehicles to collect more data of the certain type.

19. The method of claim 11, wherein the collecting data with onboard sensors within a plurality of participant vehicles, further includes:
identifying, with the privacy engine, limitations on data that may be collected based on privacy laws and policies stored within the policy database; and
sending, via the wireless communication network, feedback to the plurality of participant vehicles, and prompting the plurality of participant vehicles to collect and send data in compliance with identified limitations.

20. A system for providing dynamic data broker services, comprising:
a plurality of participant vehicle having onboard sensors adapted to collect data and send such data to the system via a wireless communication network;
a database adapted to store the data received from the plurality of participant vehicles;
an application program interface adapted to receive at least one request for data from at least one user;
a supervisory engine adapted to consolidate and prioritize the at least one request for data, and to identify a need for more data of a certain type, and send, via the wireless communication network, feedback to the plurality of participant vehicles, and prompt the plurality of participant vehicles to collect more data of the certain type;
a compute engine that is adapted to apply functions that can be applied to the at least one request, wherein such functions may be pulled from a library stored within the system and may be identified within the at least one request;
a data engine adapted to receive data from a plurality of external sources via the wireless communication network, and to combine, the data received from the plurality of external sources with the data received from the plurality of participant vehicles; the system further adapted to identify data that is relevant to the at least one request;
a policy database adapted to store privacy laws and policies therein;
a privacy engine adapted to:
process the at least one request to identify limitations on data that may be provided to the at least one user based on the privacy laws and policies stored within the policy database that are applicable to the at least one request, and to modify and filter the identified data that is relevant to the at least one request based on the identified limitations; and
identify limitations on data that may be collected based on privacy laws and policies stored within the policy database, and to send, via the wireless communication network, feedback to the plurality of participant vehicles, and prompt the plurality of participant vehicles to collect and send data in compliance with identified limitations;
a spatial engine adapted to identify distance and location-based aspects of the at least one request, and to modify and filter the identified data that is relevant to the at least one request based on the identified distance and location-based aspects of the at least one request;
a temporal engine adapted to identify time and frequency-based aspects of the at least one request, and to modify and filter the identified data that is relevant to the at least one request based on the identified time and frequency-based aspects of the at least one request; and
the system further adapted to tailor a response to the at least one request for data and send the response to the at least one user.
